(19) United States
(12) Patent Application Publication
(10) Pub. No.: US 2015/0250312 A1
(43) Pub. Date: Sep. 10, 2015

(54) Pivotable Spring-Loadable Product

(71) Applicant: Advantage Pharmacy Services LLC, Madison, MS (US)

(72) Inventors: John Todd Barrett, Madison, MS (US); Fred P. Schoville, Brighton, MI (US)

(21) Appl. No.: 14/627,026

(22) Filed: Feb. 20, 2015

Related U.S. Application Data
(60) Provisional application No. 61/948,145, filed on Mar. 5, 2014.

(51) Int. Cl. A47B 88/04; E05B 47/00; E05B 65/46; E05C 3/12

(52) U.S. Cl. CPC A47B 88/0414; E05C 3/12; E05C 3/124; E05B 47/0012; E05B 47/00; E05B 65/46; A47B 88/0477

(57) ABSTRACT

A pivotable spring-loadable product, and a latch and ejector assembly, which may include the product, to selectively unlatch and eject an object.

### TECHNICAL FIELD

The field to which the disclosure generally relates includes spring-loadable products, for example, latches and related componentry.

### BACKGROUND

Latches have many uses, for example, to latch drawers to cabinets. Conventional latches typically include complex mechanical parts and kinematics, and costly electrical devices and configurations. Also, although conventional latches may be used to latch and unlatch objects, they are not used to eject the objects.

### BRIEF SUMMARY

The present disclosure is directed to a pivotable spring-loadable product, and a latch and ejector assembly, that may include the product, to selectively unlatch and eject an object.

### BRIEF DESCRIPTION OF THE DRAWINGS

Illustrative embodiments of the invention will become more fully understood from the detailed description and the accompanying drawings, wherein:

FIG. 1 is a perspective view of an apparatus according to one illustrative embodiment, and illustrating a drawer exploded out of a corresponding compartment;

FIG. 2 is an exploded perspective view of an illustrative embodiment of the drawer of the apparatus of FIG. 1;

FIG. 2A is a front perspective view of a rear cover for the drawer of FIG. 2;

FIG. 2B is a rear perspective view of the rear cover of FIG. 2A;

FIG. 2C is a sectional side view of the rear cover of FIG. 2A, taken along line 2C-2C from FIG. 2A;

FIG. 3 is a perspective view of an illustrative embodiment of a latch and ejector assembly that may be used to selectively unlatch and eject the drawer of FIG. 2 with respect to a backplane of the apparatus of FIG. 1;

FIG. 4 is an exploded perspective view of the assembly of FIG. 3;

FIG. 5 is a fragmentary side view of a portion of the apparatus of FIG. 1, illustrating the latch and ejector assembly of FIG. 3 in an initial engagement position with a rear portion of the drawer of FIG. 2;

FIG. 6 is a fragmentary side view of a portion of the apparatus of FIG. 1, illustrating the latch and ejector assembly of FIG. 3 in a latched position with respect to one of the drawers of FIG. 1;

FIG. 7 is a fragmentary side view of a portion of the apparatus of FIG. 1, illustrating the latch and ejector assembly of FIG. 3 in an unlatched ejection position with respect to one of the drawers of FIG. 1;

FIG. 8 is a fragmentary side view of a portion of the apparatus of FIG. 1, illustrating the latch and ejector assembly of FIG. 3 in a home position of a latch and ejector with a cam rotated over half-way of a full revolution;

FIG. 9 is an example electrical schematic for a portion of the apparatus of FIG. 1; and

FIG. 10 is a schematic side view of a portion of apparatus according to another illustrative embodiment, and illustrating a multi-lobed cam and ejector arrangement.

### DETAILED DESCRIPTION OF ILLUSTRATIVE EMBODIMENTS

The present disclosure is directed to a pivotable spring-loadable product, and a latch and ejector assembly, that may include the product, to selectively unlatch and eject an object. Although the product and the assembly are described below with reference to a particular type of apparatus in the medical field, those of ordinary skill in the art will recognize that the product and the assembly may be used with any suitable types of apparatuses in any other suitable fields. Accordingly, the following description of the embodiment(s) is merely illustrative in nature and is in no way intended to limit the invention, its application, or uses.

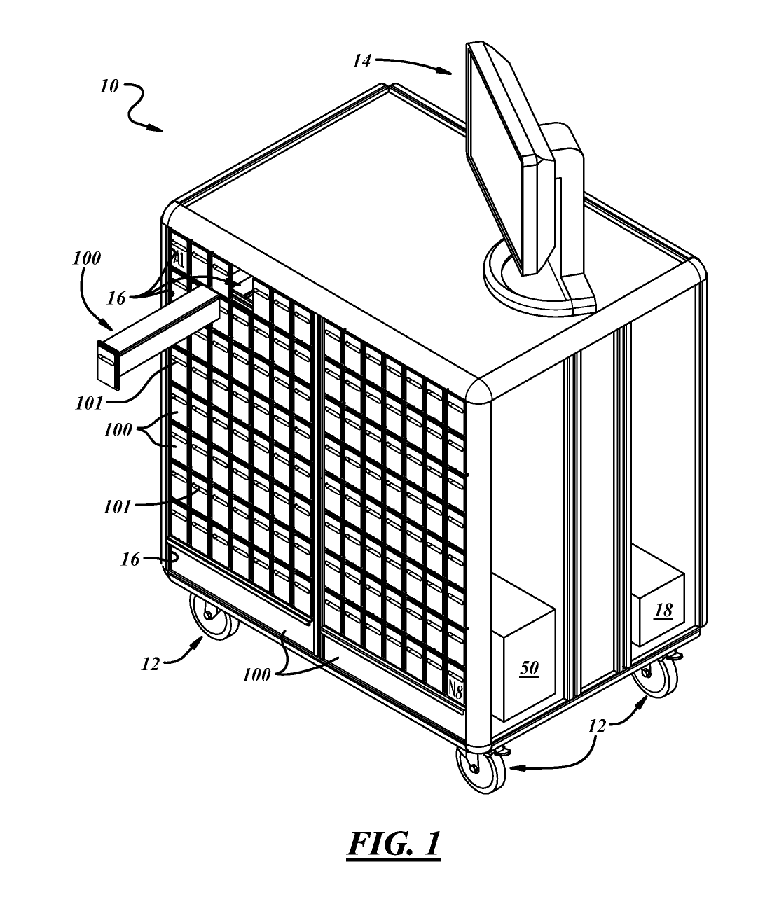

FIG. 1 illustrates an apparatus 10, which, according to an example embodiment, may include a mobile, computerized, medication administering cart, as shown. For example, a plurality of wheels 12 may be mounted to the apparatus 10 to permit transport of the apparatus 10 from room to room by a medication administering attendant while making patient rounds. In another embodiment, the apparatus 10 may be stationary, for example, built into a workstation, cabinet, desk, or the like in any suitable facility. Also, the apparatus 10 may include a touch screen monitor 14 mounted on the apparatus 10 for easy access and view by the attendant. The touch screen monitor 14 may be further equipped with a conventional mouse or keyboard or replaced with a conventional monitor equipped with a conventional mouse or keyboard. Further, the apparatus 10 may include a cabinet or housing (either for the mobile cart or the stationary apparatus embodiments) including a plurality of compartments 16 for receiving cassettes or drawers 100 that may be used to store medication, bandages and other types of medical supplies as well as other medications that cannot be easily packaged such as medications in liquid form, creams, lotions, powders, etc. for administering to a patient. For security purposes, such drawers 100 may be locked or latched. As used herein, the terms latch and unlatch are used in their ordinary sense to include any suitable coupling and uncoupling of an object.

The drawers 100 may be arranged in the apparatus 10 in an array, as shown, or in any other suitable arrangement. In an array, the drawers 100 may be identified by column and row. For example, as shown in FIG. 1, there are eight rows and fourteen columns that may be identified alphanumerically. For instance, the rows may be identified as rows A through N and the columns may be identified as columns one through eight. As used herein, the term “drawer” includes any suitable device or component that may be slid into and out of another apparatus, for example, a cabinet, cart, or the like.

The apparatus 10 also may include a computer 50 and one or more batteries 18 for powering the computer 50, drawers 100, an EEPROM/RFID (STMicroelectronics M24LR 64E-R), release mechanisms, and any other powered elements of the apparatus 10. Of course, the apparatus 10 may be supplied with power in any other suitable manner, including AC utility or generator power, or the like.

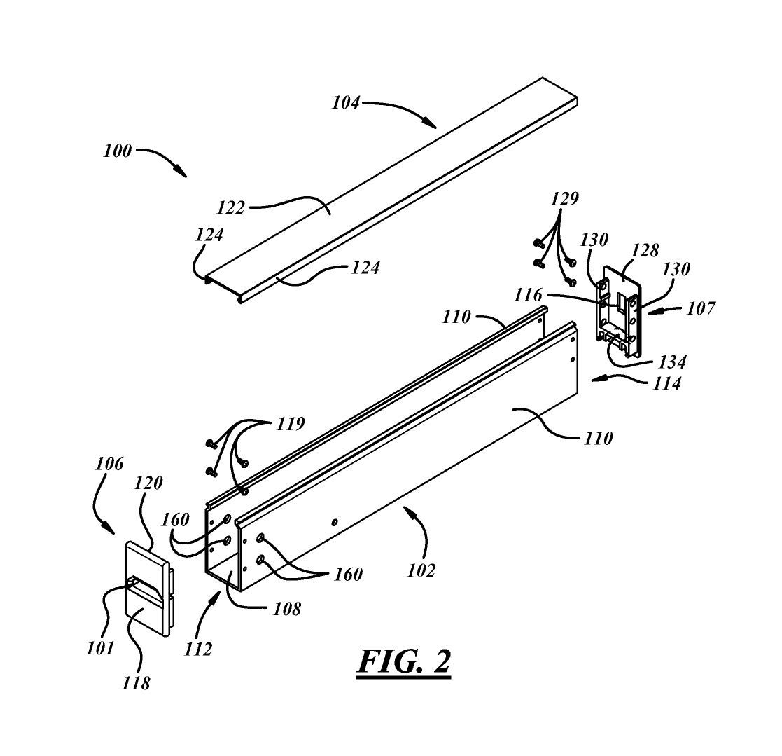

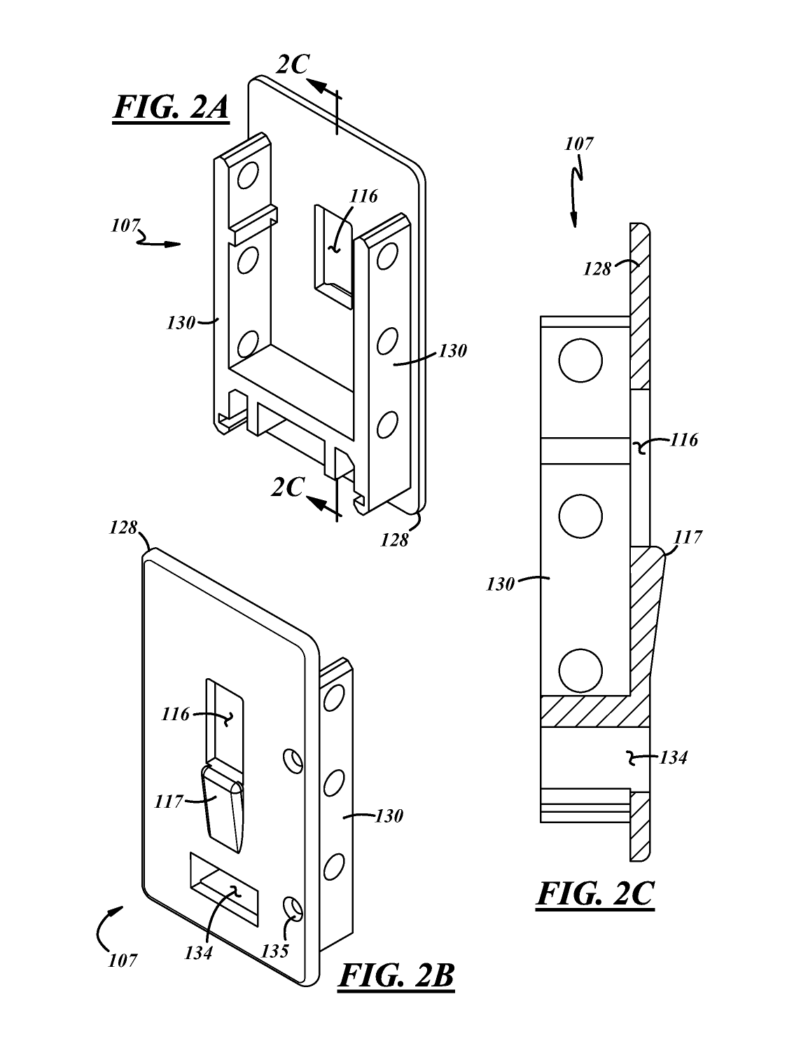

In a particular example illustrated in FIG. 2, the illustrative drawer 100 includes a housing that may be comprised of a main body 102 to provide support for other portions of the drawer 100, a top cover 104 that covers the main body 102, and a front cover 106 that frontally covers the main body 102 and includes an outlet 101, for example a slit, through which medication may be conveyed, and a rear cover 107 that covers a rearward end of the main body 102. The main body 102 includes a base 108, sides 110 extending from the base 108, a front 112 to which the front cover 106 is coupled in any suitable manner, and a rear 114. The main body 102 may be a drawer base identifiable by part number FS1.5×3LG6NM available from PANDUIT of Tinley Park, Ill., or may be custom molded, for example, using ALUMILITE brand molds and techniques, or may be constructed and arranged in any other suitable manner from any other suitable materials.

The top cover 104 includes a top base 122 and flanges 124 extending therefrom, wherein the top cover 104 is coupled to the main body 102 in any suitable manner. For example, the sides 110 of the main body 102 may be frictionally engaged to the flanges 124 of the top cover, or the sides 110 of the main body 102 may be frictionally slidably interengaged to the flanges 124 of the top cover 104. The top cover 104 may be identifiable as part number C1.5LG6 available from PANDUIT of Tinley Park, Ill. The top cover 104 also may be custom molded, for example, using ALUMILITE brand molds and techniques.

The front cover 106 includes a front portion 118, a rear portion 120 coupled to the main body 102, and the outlet 101 extending therethrough. The front cover 106 may include flanges extending from the rear portion 120 for coupling to the sides 110 of the main body 102 in any suitable manner, for example via fasteners 119.

Referring to FIGS. 2A through 2C, the rear cover 107 may include a base 128, and flanges 130 extending from the base 128 for coupling to the sides 110 of the main body 102 of the drawer housing in any suitable manner for example via frictional fit, fasteners or the like. The rear cover 107 may include a latch aperture 116, a connector passage 134 that may extend through the base 128, and a guide pin passage 135 (FIG. 2C). The rear cover 102 also may include a cam surface 117 extending from the base 128 and arranged adjacent a lower portion of the aperture 116.

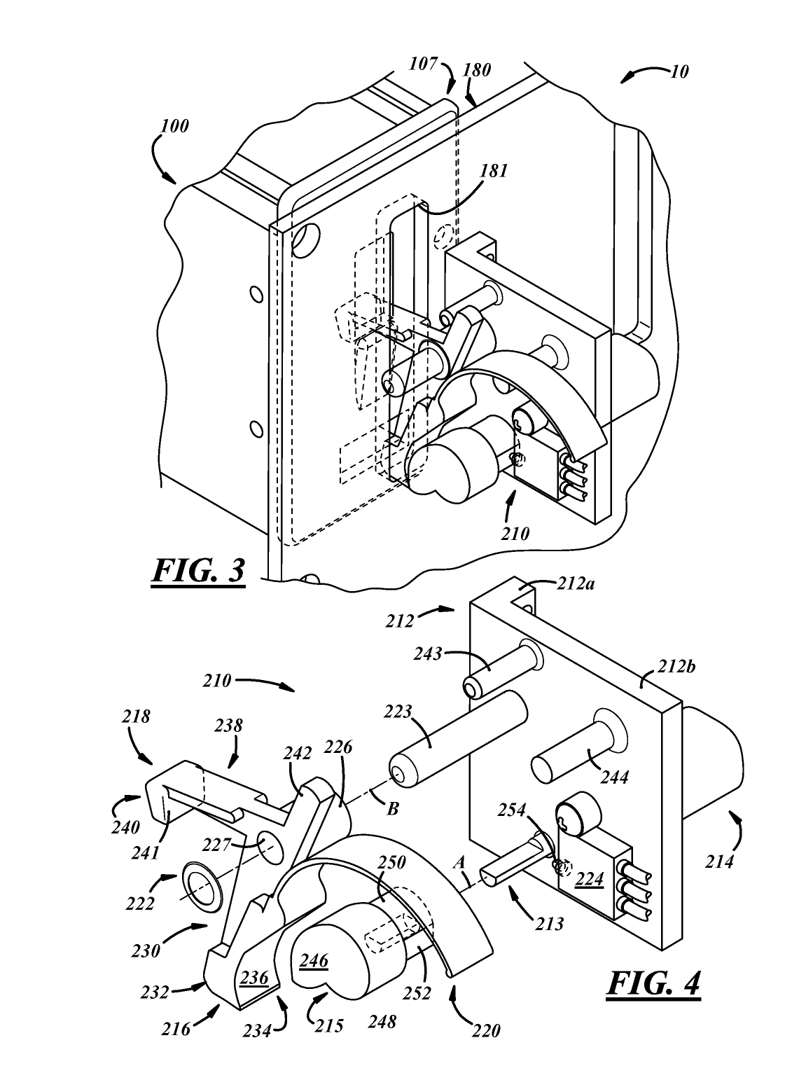

As shown in FIG. 3, a backplane 180 may be coupled in any suitable manner to the apparatus 10, and a latch and ejector assembly 210 may be coupled to the backplane 180 to selectively couple the drawer 100 to the apparatus 10. The backplane 180 may include one or more circuit boards that may be coupled, for example, to structural members or internal framework of the housing of the apparatus 10. The backplane 180 may include a backplane aperture 181 to allow one or more portions of the latch and ejector assembly 210 to extend therethrough as will be described in further detail below. Although not shown, any suitable hard stops may be provided between the drawer 100 and the framework of the apparatus housing to prevent the drawer 100 from damaging the backplane 180, for example, in the event that the drawer 100 is slammed to its closed position.

Referring to FIG. 4, the latch and ejector assembly 210 may include a bracket 212 for mechanical coupling to the backplane 180 (FIG. 3) in any suitable manner, for example, with pins, clips, fasteners, or the like. The latch and ejector assembly 210 also includes an actuator 214 to produce rotational motion, and a cam 215 operatively coupled to the actuator 214 for rotation about a rotational cam axis A. The cam 215 may be rotationally fixed with respect to the actuator 214, for example via a shaft 213 with one or more flats, splines, or any other suitable interface(s). The assembly 210 also may include an ejector 216 operatively coupled, directly or indirectly, in a pivotable manner, with respect to the cam 215 to pivot the ejector 216 about a pivotal ejector axis B. The assembly 210 further may include a latch 218 that may be coupled, directly or indirectly, to the ejector 216. In the illustrated embodiment, the ejector 216 and the latch 218 are an integrally constructed component but, in other embodiments, may be separate components that may be coupled together by welding, fastening, or in any other suitable manner. The latch and ejector assembly 210 also may include a spring 220 operatively coupled to the ejector 216 and/or the latch 218 to yieldably bias the ejector 216 and/or latch 218 about the axis B to a home position or normal latch position. The assembly 210 further may include a fastener 222 to retain the ejector 216 and/or the latch 218 to a support 223. In other embodiments, the ejector 216 and/or the latch 218 may be coupled to the support 223 by bending, melting, welding, deforming, or otherwise modifying the end of the support 223. The support 223 may include an integral portion of the bracket 212, a post carried by the bracket 212, or any other suitable structure. The latch and ejector assembly 210 further may include a sensor 224 to provide an indication of a rotational position of the cam 215.

The bracket 212 may have a first flange 212a coupled to the backplane 180 (FIG. 3) by fastening, welding, staking, or in any other suitable manner, and a second flange 212b which may extend at a ninety degree angle from the first flange 212a, or at any other suitable angle. The actuator 214 or a portion thereof may be carried by the bracket 212 on one side of the second flange 212b, and the ejector 216 and latch 218 may be disposed on another side of the second flange 212b.

The actuator 214 may include a powertrain, which, in one embodiment includes an electrical motor, and in another embodiment also may include a drivetrain coupled to the motor. The drivetrain may include a gearbox, belt and pulley reducer, or the like, or any other suitable type of speed reducer. In any case, the motor may be powered and controlled in any suitable manner and may be electrically coupled to the backplane 180 in any suitable manner. For example, the powertrain may include a GM 10 geared pager motor product available from Solarbotics of Calgary, Canada. The actuator 214 may be coupled to the bracket 212 by fasteners, pins, clips, or the like, or in any other suitable manner. In any event, the actuator 214 includes the output shaft 213 that may extend through the bracket 212, for example, through the second flange 212b.

The ejector 216 may include an ejector hub 226 that may be coupled to the support 223 in any suitable manner, for example, via slip fit through a passage 227 through the hub 226. The ejector 216 may include an ejector arm 230 that extends radially outwardly from the ejector hub 226 and terminates in an end 232 that may be rounded, sloped, or otherwise profiled for cooperation with the drawer 100 (FIG. 3) as will be described herein below. The ejector arm 230 has a rearward portion 234 that may include an incurvate profile 236 for cooperation with the cam 215.

The latch 218 may include a latch arm 238 extending in a direction radially outwardly from the hub 226 and having a bayonet end 240 with a barb 241. The ejector 216 and the latch 218 may be unitary, and may integrally extend from the hub 226.

In any case, the ejector 216 and/or the latch 218 may include an extension 242 extending in a direction away from the hub 226 and above the pivot axis B. The extension 242 may engage a pivot stop 243 in the home position. The pivot stop 243 may include an integral portion of the bracket 212, a post carried by the bracket 212, or any other suitable structure.

Still referring to FIG. 4, the spring 220 may be operatively coupled to the ejector 216 and/or the latch 218 to yieldably bias the ejector 216 and the latch 218 to the home position. In the illustrated embodiment, the spring 220 is operatively coupled to both the ejector 216 and the latch 218 but, in other embodiments, the spring 220 may be operatively coupled to one or the other. For example, the spring 220 may extend from the latch 218, instead of the ejector 216, or may extend from only a latch or only an ejector. In any case, the spring 220 may be a leaf spring and may have a portion that extends arcuately in the home position and, as illustrated, takes the form of a rooster-tail-like configuration with a fixed end and a free end. The spring 220 may extend from a first or fixed end of the spring 220 at a location on one side of (e.g. below) the pivot axis B to a second or free end of the spring 220 at a location on an opposite side of (e.g. above) the axis B. The spring 220 also may include an intermediate portion that may extend along an arcuate path between the first and second ends. The spring 220 may extend semi-circumferentially, for example, about 180 angular degrees, as in the illustrated embodiment. In other embodiments, the spring 220 may extend between 30 and 270 angular degrees, including all ranges and subranges therebetween. In a preferred embodiment, the spring may extend at least 90 angular degrees. The spring 220 may extend in a generally semi-circular manner, which may include a partial circle shape, strictly speaking, or a semi-circle-like shape that need not be in the form a perfect semi-circle per se. For example, the spring 220 may extend in a semi-ovular manner, or in any other arcuate manner.

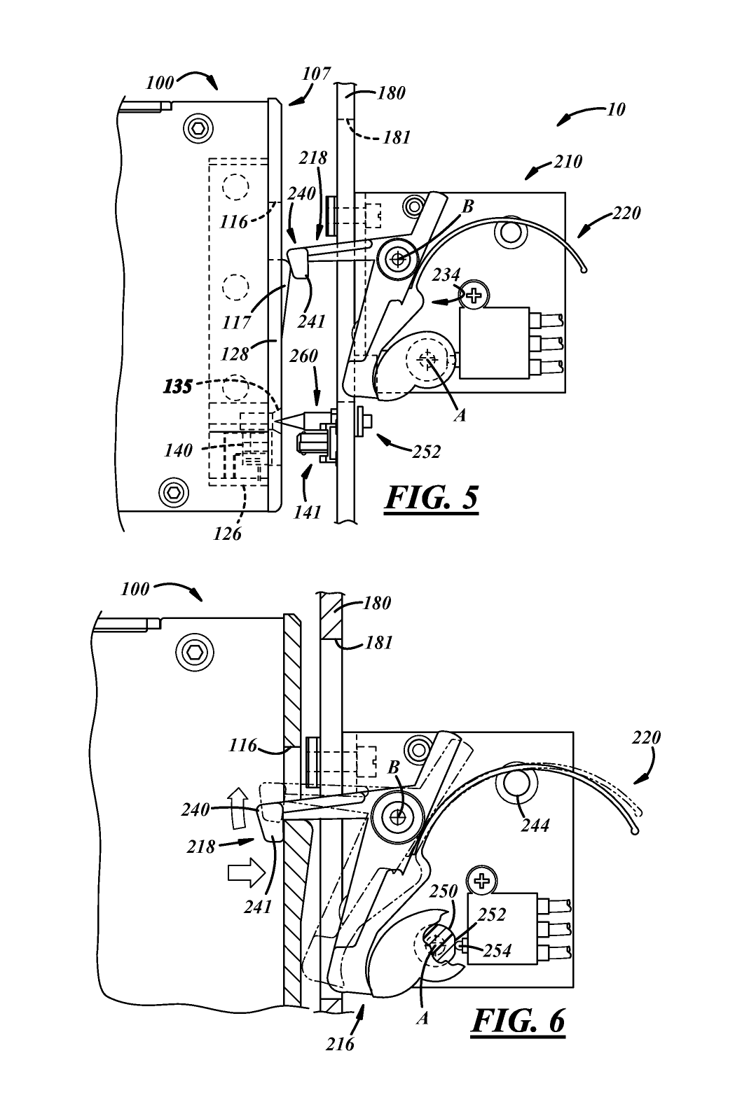

In the illustrated embodiment, the spring 220 may extend integrally from the rear portion 234 of the ejector arm 216 but, in other embodiments, the spring 220 may be a separate component coupled to the arm 216, for example, via welding, fastening, or in any other suitable manner. As in the illustrated example, best shown in FIG. 5, the fixed end of the spring 220 may be spaced apart from a rear surface of the rear portion 234 of the ejector arm 216, and may curve arcuately toward that rear surface before curving away from it. The ejector arm 230 is relatively rigid to allow the arm 216 to eject the drawer, whereas the spring 220 is relatively resiliently flexible to allow the spring 220 to yieldably bias the ejector 216 to its home position. Where the spring 220 and the arm 230 are of one integral piece, relative thickness of the arm 230 may provide the rigidity and relative thinness of the spring 220 may provide the flexibility.

The assembly 210 also may include a reaction member 244 offset from both of the axes A, B and against which the spring 220 locates to yieldably bias the ejector 216 toward the home position. The reaction member 244 may include an integral portion of the bracket 212, a post carried by the bracket 212, or any other suitable structure. The spring 220 may be movably engaged against the reaction member 244 to accommodate pivoting movement of the arm(s) 216, 218 and to yieldably bias the arm(s) 216, 218 toward a home position. In other words, the spring 220 may be in sliding engagement with the reaction member 244 over a portion of the spring 220. The shape of the spring 220 may provide a good combination of flexing and relative movement of the spring 220 over the reaction member 244 when the ejector 216 pivots about the pivot axis B.

The fastener 222 may include a retaining nut, speed nut, Tinnerman nut, clip, or any other suitable fastener. The fastener 222 may be coupled to the end of the pivot support 223, for example, by pressing, staking, threading, or in any other suitable manner.

The cam 215 may include a cam lobe 246 establishing a major diameter of the cam 215, to cooperate with the rear portion 234 of the ejector 216 to pivot the ejector 216 about its pivot axis B. The cam 215 also may include a cam base 248 from which the lobe 246 projects outwardly, and a cam hub 250 that may extend axially from the cam lobe 246 and/or base 248, may be of smaller diameter compared thereto, and may include one or more corresponding features to couple to the shaft 213, for example, a blind or through hole that may be provided with splines, a flat, or any other suitable coupling feature(s). The hub 250 may include a rotational position reference 252, which may in the form of a flat, detent, or any other suitable feature, for cooperating with a portion of the sensor 224 as will be described herein below.

The sensor 224 may be operatively coupled to the cam 215, may be electromechanical, and may include a translatable armature or plunger 254 to cooperate with the positional reference 252 of the cam 215. The sensor 224 may be coupled to the bracket 212 by clips, pins, fasteners, or the like, or in any other suitable manner. Also, the sensor 224 may be disposed on the same side of the second flange 212b of the bracket 212 as the ejector 216 and the latch 218. The sensor 224 may be electrically coupled in any suitable manner to one or both of the actuator 214 and/or the computer 50 (FIG. 1), either directly, or indirectly via the backplane 180 or in any other suitable manner. In other embodiments, the sensor 224 may be electro-optical (e.g. infrared sensor), another type of non-contact sensor, or any other suitable type of sensor, switch, or the like.

Referring now to FIG. 5, each drawer 100 may include an electrical connector 140 that may be coupled to and carried by a circuit board 126 in any suitable manner, for example, by soldered pins. In turn, the circuit board 126 may be carried by the housing of the drawer 100 in any suitable manner. Likewise, the apparatus 10 also may include an electrical connector 141 that may be coupled to the backplane 180 in any suitable manner, for example, by soldered pins. The connector 141 may be the counterpart connector for the drawer connector 140 and, for example, also may be from FCI of Versailles Codex, France. The connectors 140 and 141 may be blind hole connectors and are coupled to their respective supports such that they align and engage with one another. The connectors 140, 141 may be 10 pin connectors, and one or both may incorporate a floating insertion feature that allows a male end of the connector(s) to float horizontally and vertically making insertion easier. Of course, although not shown in the drawings, any suitable power and data wires or the like may be coupled between the latch and ejector assembly 210 and connector 141 and corresponding portions of the apparatus 10, such as a power supply, computer, and/or the like. The connectors 140, 141 may be low friction connectors constructed so that the drawer connector 140 is inherently guided into the mating cart connector 141 with little to no effort, for example, 0.1 to 0.4 lbs of force and, more specifically about 0.2 lbs of force. Also, the low friction connectors 140, 141 are constructed so that the drawer connector 140 is easily disengaged from the mating cart connector 141 when the drawer 100 is unlatched from the housing of the apparatus 10.

The backplane 180 may be communicated in any suitable manner to the computer 50 (FIG. 1), which is in communication with the connectors 141 and is programmed in accord with the array of compartments 16 (FIG. 1). Accordingly, the locations of the drawers 100 in the compartments 16 (FIG. 1) can be communicated to and stored in the computer 50 in any suitable manner.

The apparatus 10 also may include a guide pin 260 that may be coupled to the backplane 180 to align the drawer 100 with respect to the backplane 180 for good alignment of the connectors 140, 141 and the latch and ejector assembly 210 with respect to the latch aperture 116. For example, the guide pin 260 may extend through the backplane 180 and a fastener 252 may fasten the guide pin 260 to the backplane 180. The guide pin 260 is adapted for cooperation with the guide pin passage 135 of the drawer 100.

In use, and with respect to FIG. 5, the drawer 100 may be pushed toward the backplane 180 wherein the latch 218 contacts a rear wall of the drawer 100, for example, the rear surface of the rear cover 107 of the drawer 100. Also, the guide pin 260 engages the guide pin passage 135, and the connectors 140, 141 eventually engage one another. The cam surface 117 of the rear cover 107 may initially engage an angled surface at the bayonet end of the latch 218, and the guide pin 260 may engage the corresponding passage 135 to stably pilot the drawer 100 for good connector alignment and engagement.

As the drawer 100 continues advancing and nears its closed position, the connectors 140, 141 operatively engage. At this point, the computer 50 (FIG. 1) may recognize the drawer 100 using, for example, any suitable plug-and-play utility like USB, or the like. In other words, the connectors 140, 141 may be configured as part of a drawer presence detection device wherein the computer 50 recognizes that the drawer 100 is engaged to the apparatus 10 when the connection between the connectors 140, 141 is made. For example, the computer 50 may periodically poll the memory devices 142 (FIG. 2A) via the connectors 140, 141 and read serial numbers and other data of the memory devices 142.

As shown in FIG. 6, the drawer 100 may continue to be pushed toward the backplane 180 wherein the latch 218 and the ejector 216 pivot (as indicated by hidden lines) from the home position (shown in FIG. 5), and the bayonet end 240 of the latch 218 projects through the latch aperture 116 until the barb 241 clears a rear inside surface of the drawer 100 adjacent the aperture 116. At that point, the latch 218 can drop or move into a latched position with the barb 241 engaged with the base wall 128 of the rear cover 107 of the drawer 100. The spring 220 loads up against the reaction member 244 to yieldably bias the ejector 216 and the latch 218 toward the home position. The drawer 100 will remain in the latched state until a signal is sent from the computer 50 (FIG. 1) of the apparatus 10 to the actuator 214 (FIG. 4) to unlatch the drawer 100. The home position and latched position of the latch 218 may be the same. In the home position, the cam reference 252 may be in a home position with respect to the sensor 224. More specifically, the plunger 254 may be engaged with the reference 252 in the cam hub as shown.

In operation, and with reference to FIG. 1, an attendant may use the touchscreen 14 in communication with the computer 50 to request unlatching of the drawer 100 and, in turn, the computer 50 may send any suitable signal(s) to the latch and ejector assembly 210 (FIG. 4), for example, via a dedicated output for each drawer via an input/output rack of the apparatus 10.

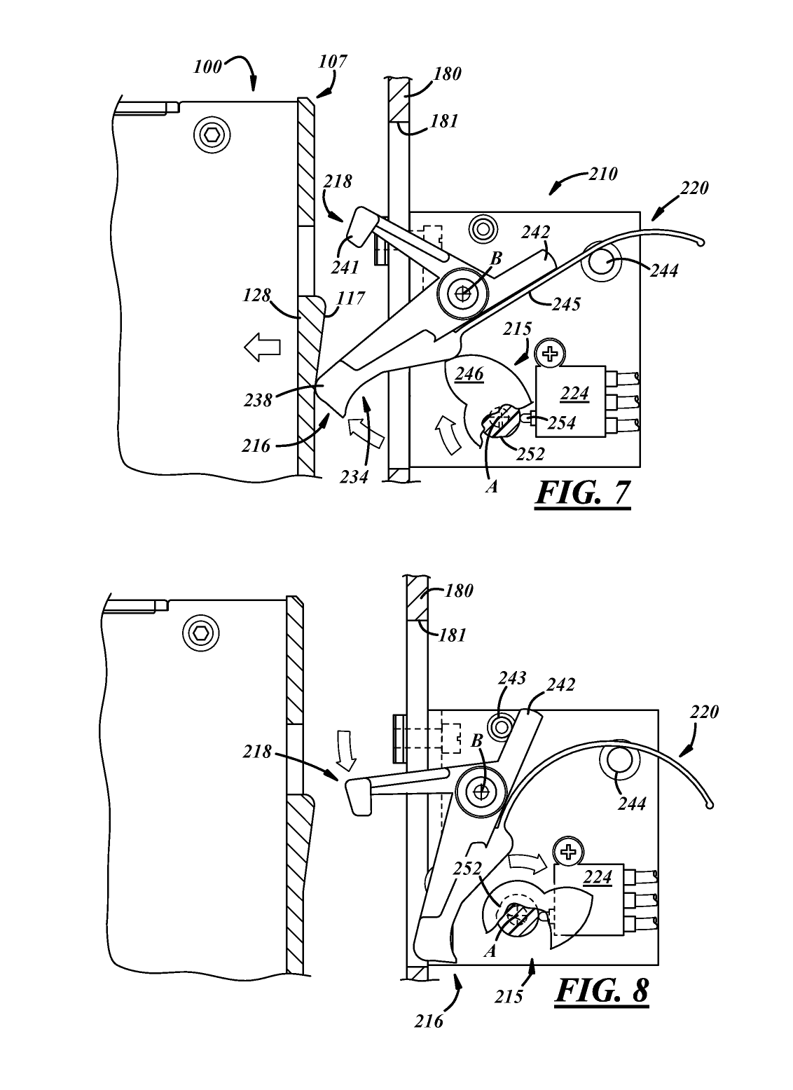

With reference to FIG. 7, when the actuator 210 (FIG. 4) is energized, the cam 215 rotates so as to pivot the ejector 216 and the latch 218. More specifically, the cam lobe 246 engages the rearward portion 234 of the ejector 216 to displace the ejector 216 in a direction away from the cam axis A and rotationally about the ejector axis B. The latch 218 rotates so that the barb 241 of the latch 218 disengages from the base 128 of the rear cover 107 of the drawer 100. Likewise, the ejector 216 rotates through the backplane aperture 181 and contacts the drawer 100. More specifically, the end 238 of the ejector 216 contacts the rear surface of the rear cover 107 including the cam surface 117. The engagement of the ejector 216 with the drawer 100 causes ejection or outward displacement of the drawer 100 relative to the backplane 180.

Additionally, the spring 220 rides or floats over the reaction member 244 and, yet, loads up against the reaction member 244 to further yieldably bias the ejector 216 and the latch 218 back toward the home position. The assembly 210 may be configured such that a rear surface of the ejector 216 (for example, a rear surface of the extension 242), contacts the spring 220 in a location between the pivot axis B and the reaction member 244 as shown in FIG. 7, when the ejector 216 is ejecting the drawer 100. Such contact in a location spaced from the fixed end of the spring 220 may better distribute the force on the spring 220, for example, so as to reduce the torque on the fixed end of the spring 220 coupled to the ejector 216 when the spring 220 is being loaded up. Accordingly, the fixed end of the spring 220 may experience more lateral force at the expense of rotational force for good durability of the spring 220, particularly at the fixed end thereof. In FIG. 7, it can be seen that the spring 220 has been pulled over the reaction member 244 toward the pivot axis B by the pivoting motion of the ejector 216. The ejector 216 may include a portion (e.g. the arm 230) extending in a direction from the pivot axis B to one side thereof, and the extension 242 extending in a direction from the pivot axis B to the opposite side thereof. The ejector 216 may have a bearing surface 245 that engages the arcuately extending portion of the spring 220 in a pivoted position of the arm 218, as shown in FIG. 7.

Also, the position reference 252 has rotated with respect to the sensor 224, wherein the sensor 224 is in such a state so as to ensure that power is continuously supplied to the actuator 214 until the position reference 252 and the sensor 224 are realigned. For example, the plunger 254 of the sensor 224 may be depressed so as to activate the sensor 224 in a closed-loop configuration to complete a circuit so that power continues to be supplied to the actuator 214 for a full revolution of the cam 215.

As shown in FIG. 8, the ejector 216 and the latch 218 pivot back to the home position under the yieldable bias force of the spring 220, wherein the extension 242 may locate against the stop 243 to provide a positive stop home position for the ejector 216 and the latch 218. The cam 215, however, may continue rotating over a full revolution back toward its cam home position. The full rotation can be accomplished in any suitable manner but, in one example, the sensor 224 may be activated so that power continues to flow to the actuator 214 (FIG. 4) in a closed circuit until the positional reference 252 and the sensor 224 realign to open the circuit and de-energize the actuator 214 (FIG. 4). The computer 50 (FIG. 1) may sense disengagement of the electrical connectors 140, 141 (FIG. 5) using, for example, any suitable plug-and-play utility like USB, or the like, or in any other suitable manner.

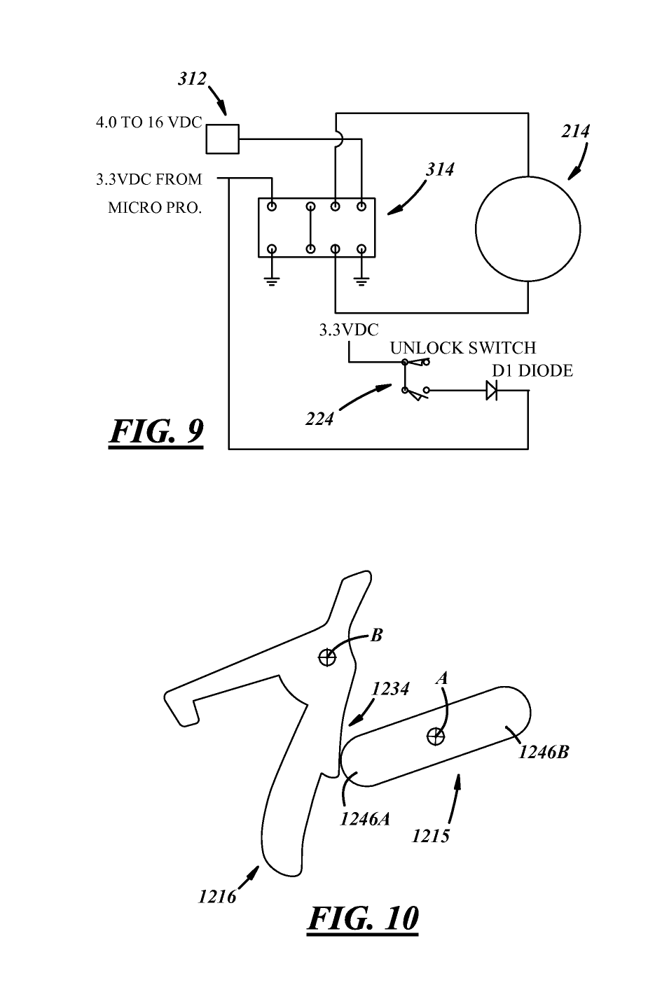

As shown in FIG. 9, each drawer may be associated with an electrical configuration 310 that may include a power supply 312, the actuator 214, and the sensor 224. The power supply 312 may include a direct connection to the batteries 18 of FIG. 1 or an indirection connection thereto via a power distribution block or the like. Power may be communicated to the actuator 214 via a relay 314 that may include a connection to the power supply 312 and one end of the sensor 224. The sensor 224 may have ends or poles across which the sensor may be activated to connect the poles. In the illustrated embodiment, the sensor 224 may include a normally open switch, but a normally closed switch instead may be used. The relay 314 may be a PANASONIC brand relay, model TX2-5V available from Future Electronics of Quebec, CA. A drive signal may be communicated to the relay 314 via any suitable microprocessor (for example via the computer 50) to an input on the relay 314.

Accordingly, a drive signal from the microprocessor may activate the relay 314 to power to the actuator 214, causing the cam 215 to rotate and, thus, actuate the sensor 224 away from its home position or condition to close the circuit for continued activation of the relay 314, and for dropping of the drive signal from the microprocessor. When the cam 215 rotates for one revolution and returns to its home position, the sensor 224 also returns to its home position or condition by virtue of the interaction between the cam 215 and the sensor 224. Accordingly, the circuit opens and power is dropped thereby deactivating the relay 314. For example, when the relay 314 is deactivated, the power leads to the actuator 214 have been shorted or jumped together to brake the actuator 214 quickly.

In general, the components of the apparatus 10 may be manufactured according to techniques known to those skilled in the art, including molding, machining, stamping, and the like. Also, the apparatus 10 may be assembled according to known techniques. Likewise, any suitable materials can be used in making the components, such as metals, composites, acetal polymers or other polymeric materials, and the like.

FIG. 10 illustrates another illustrative embodiment of an apparatus. This embodiment is similar in many respects to the embodiment of FIGS. 1-9 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

As illustrated in FIG. 10, a multi-lobe cam 1215 may rotate about its rotational axis A and may include multiple cam lobes 1246A, 1246B establishing a major diameter of the cam 1215, to cooperate with a rear portion 1234 of an ejector 1216 to pivot the ejector 1216 about its pivot axis B. Accordingly, the cam 1215 need not revolve completely 360 degrees around and, instead, may only partially revolve, for example, to disengage and eject a drawer. In the illustrated example, the cam 1215 includes two equidistantly circumferentially spaced lobes 1246A,B such that the cam 1215 need only rotate about 180 degrees. In other embodiments, however, a cam can include any integer (n) of lobes so that the cam requires only 360/n degrees of rotation of the cam.

In any case, the actuator need not rotate over a full revolution. Also, the cam 1215 may include a quantity of rotational position references that may correspond in quantity to the cam lobes 1246A,B. In any case, during operation, the actuator rotates the cam 1215 for less than a full revolution and the cam 1215 stops at one of multiple home positions of the cam 1215 and, concomitantly, the sensor plunger may cooperate with one of the rotational position references of the cam 1215 to return to the plunger home condition such that power is dropped to deactivate the relay and thereby short power leads to the actuator to brake the actuator.

As used in the sections above and claims below, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Similarly, when introducing elements of the invention or the example embodiments thereof, the articles “a,” “an,” “the,” and “the” are intended to mean that there are one or more of the elements. Moreover, directional words such as front, rear, top, bottom, upper, lower, radial, circumferential, axial, lateral, longitudinal, vertical, horizontal, transverse, and/or the like are employed by way of description and not limitation. Other terms are to be construed using their broadest reasonable meaning unless they are used in a context that requires a different interpretation.

Finally, the foregoing description is not a definition of the invention, but is a description of one or more examples of illustrative embodiments of the invention. The statements contained in the foregoing description relate to the particular examples and are not to be construed as limitations on the scope of the invention as claimed below or on the definition of terminology used in the claims, except where terminology is expressly defined above. And although the present invention has been disclosed using a limited number of examples, many other examples are possible and it is not intended herein to mention all of the possible manifestations of the invention. In fact, other modifications, variations, forms, ramifications, substitutions, and/or equivalents will become apparent to those skilled in the art in view of the foregoing description. The present invention is intended to embrace such forms, ramifications, modifications, variations, substitutions, and/or equivalents as fall within the spirit and broad scope of the following claims. In other words, the present invention encompasses many substitutions or equivalents of limitations recited in the following claims. For example, the materials, sizes, and shapes, described above could be readily modified or substituted with other similar materials, sizes, shapes, and/or the like. Therefore, the invention is not limited to the particular examples of illustrative embodiments disclosed herein, but instead is defined solely by the claims below.

What is claimed is:

1. A latch and ejector assembly comprising:
a latch pivotable about a first axis and including a latch arm to latch to an object;
an ejector pivotable about the first axis and including an ejector arm to eject the object;
a spring to yieldably bias at least one of the latch arm or the ejector arm toward a home position;
a cam rotatable about a second axis laterally offset from the first axis and engageable with at least one of the latch arm or the ejector arm; and
an actuator coupled to the cam to rotate the cam about the second axis.

2. The latch and ejector assembly of claim 1, wherein the spring includes a leaf spring that extends along an arcuate path from a fixed end at a location below the first axis to a free end at a location above the axis.

3. The latch and ejector assembly of claim 1, wherein the spring extends integrally from a rear portion of the ejector arm and wherein the ejector arm is rigid whereas the spring is resiliently flexible.

4. The latch and ejector assembly of claim 1, further comprising a reaction member offset from both the first and second axes and against which the spring locates to bias the ejector arm toward the home position.

5. The latch and ejector assembly of claim 1, wherein the ejector and the latch are unitary and share a common hub, and the latch arm has a bayonet end for latching engagement with the object.

6. The latch and ejector assembly of claim 1, wherein the actuator is operable to rotate the cam over a complete revolution to pivot the latch and the ejector to unlatch and eject the object.

7. The latch and ejector assembly of claim 1, further comprising:
a sensor operatively coupled to the cam to provide an indication of a rotational position of the cam.

8. The latch and ejector assembly of claim 7, further comprising a powered relay coupled to the sensor.

9. The latch and ejector assembly of claim 8, wherein the cam includes a rotational position reference and the sensor includes a portion for operable coupling to the rotational position reference, and wherein the sensor includes a plunger.

10. The latch and ejector assembly of claim 9 wherein a microprocessor sends a drive signal to activate the relay to power the actuator and cause the cam to rotate, wherein the sensor plunger moves away from its home position for continued activation of the relay, and dropping of the drive signal from the microprocessor.

11. The latch and ejector assembly of claim 10 wherein the cam rotates for one revolution and returns to its home position and, concomitantly, the sensor plunger returns to its home condition such that power is dropped to deactivate the relay and thereby short power leads to the actuator to brake the actuator.

12. The latch and ejector assembly of claim 10 wherein the cam includes multiple lobes and rotates for less than a full revolution and stops at one of multiple home positions and, concomitantly, the sensor plunger returns to its home condition such that power is dropped to deactivate the relay and thereby short power leads to the actuator to brake the actuator.

13. An apparatus, comprising:
a backplane having a backplane aperture therethrough;
a drawer disposed on one side of the backplane and including a rear wall having a drawer aperture therethrough; and
the latch and ejector assembly of claim 1 disposed on another side of the backplane to selectively couple the drawer to the backplane and selectively eject the drawer away from the backplane.

14. The apparatus of claim 13 wherein the latch and ejector assembly is coupled to a rear surface of the backplane.

15. The apparatus of claim 13, further comprising a mounting bracket having a first flange coupled to the backplane, and a second flange wherein the electric motor is carried by the bracket on one side of the second flange, and the ejector and the latch are disposed on another side of the second flange.

16. A pivotable spring-loadable product, comprising:
an arm pivotable about an axis; and
a leaf spring to yieldably bias the arm toward a home position and including a first end operatively coupled to the pivotable arm, a second end spaced from the first end, and an intermediate portion extending along an arcuate path between the first and second ends.

17. The product of claim 16, wherein the leaf spring takes the form of a rooster tail like configuration with respect to the arm.

18. The product of claim 16, wherein the arm has a rear surface, and the first end of the spring is spaced apart from the rear surface and the intermediate portion extends from the first end and curves toward the rear surface before curving away therefrom toward the second end.

19. The product of claim 16, wherein the ejector arm is relatively rigid whereas the spring is relatively resiliently flexible to allow the spring to yieldably bias the ejector to its home position.

20. The product of claim 16, wherein the spring extends semi-circumferentially between 30 and 270 angular degrees.

21. An assembly comprising:
the product of claim 16; and
a reaction member offset from the axis,
wherein the leaf spring extends along a path from the first end at a location on one side of the axis to a second end at a location on an opposite side of the axis and is movably engaged against the reaction member to accommodate pivoting movement of the arm and to yieldably bias the arm toward the home position.

22. The assembly of claim 21 wherein the leaf spring is of arcuate shape with a portion that extends arcuately in the home position, and the arm includes a portion extending in a direction from the axis to one side of the axis and an extension extending in a direction from the axis to an opposite side of the axis and having a bearing surface that engages the arcuately extending portion in a position of the arm pivoted away from the home position.
